(19) United States
(12) Patent Application Publication
(10) Pub. No.: US 2017/0189155 A1
(43) Pub. Date: Jul. 6, 2017

(54) OESTRUS DETECTION SYSTEM

(71) Applicant: LIC AUTOMATION LTD, Hamilton (NZ)

(72) Inventors: Andrew David CROSBY, Hamilton (NZ); Christopher Lewis ANDERSON, Hamilton (NZ); Peter Stephen CROSS, Cambridge (NZ)

(21) Appl. No.: 15/510,573

(22) PCT Filed: Sep. 9, 2015
(86) PCT No.: PCT/NZ2015/050134

§ 371 Date: Mar. 10, 2017

(30) Foreign Application Priority Data
Sep. 12, 2014 (NZ) 631487

(51) Int. Cl. A61D 17/00; A01K 11/00; A01K 29/00; A01K 1/00

(52) U.S. Cl. CPC A61D 17/002; A01K 1/0023; A01K 11/006; A01K 29/00

(57) ABSTRACT

An apparatus (100) for automatically detecting a status of an oestrus indicator associated with an animal is disclosed. The apparatus (100) comprises a structure having two substantially parallel barrier means (1) and moveable barrier means (2) for selectively preventing an animal from proceeding between the parallel barrier means (1). A camera (11) is provided for capturing an electronic image of an area of interest of the animal (A), the area of interest comprising an area of the animal (A) which the oestrus indicator is usually associated with or attached to. Processing means (300) determine a status of the oestrus indicator based on the image. Animal position sensing means (6) are also provided, wherein, in use, closing of the moveable barrier means (1) is dependent on the animal position sensing means (6) detecting that a required portion of the animal (A) has moved past the moveable barrier means (1). A method of automatically detecting a status of an oestrus indicator associated with an animal is also disclosed.

The present invention relates to apparatus and methods for detecting oestrus in an animal, and in particular, but not exclusively, to apparatus and methods for detecting oestrus in cows.

### BACKGROUND TO THE INVENTION

Correct detection of oestrus (heat) is important on dairy farms with artificial breeding (AB) programmes. A missed heat means a three week delay in inseminations, resulting in lost productivity in subsequent seasons due to an increased calving spread. Unfortunately, modern day dairy herd sizes are often large and farm workers often do not have the required skill or time for accurate visual inspection of every cow during each milking. To ensure submission rates are maximised, farmers often employ heat detection aids such as tail paint or pedometers, rather than relying on observation alone. However, many of these aids still rely on manual inspection to determine oestrus.

Pressure sensitive heat detection devices such as the Kamar® HeatMount™ Detector (Kamar Inc., Steamboat Springs, Colo., USA), Tattle Tale™ Timed Mount Heat Detector (The Microdyne Co, LLC, St Joseph, Mo., USA) HeatWatch® (CowChips LLC, Manalapan, N.J., USA) and Bulling Beacon® (Beacon Marketing Pty Ltd, Muswellbrook, New South Wales, Australia) are available as alternatives to tail paint. These devices give a simple yes/no assessment of whether mounting has occurred. Some, such as Kamar® HeatMount™ Detectors or Bulling Beacons®, use a coloured fluid that fills a container when pressure is applied.

Automated systems are available to monitor the status of these pressure sensitive devices. Examples of such systems are described in NZ patent Nos. 564384 and 528756. These systems use cameras to detect a change in colour of the pressure sensitive device.

A number of conditions must be satisfied for the automated systems of the prior art to function correctly: the region of the animal which is of interest must be within the area captured by the image; the region must not be obscured; and the image must not contain heat detection devices from two or more animals. It is also strongly preferable that the system analyses the status of the device quickly enough to allow the animal to be drafted immediately after the image is collected.

It would be advantageous to develop a system which was not reliant on integration with a rotary milking shed in order to function properly, and which allows a high throughput of animals.

The reference to any prior art in the specification is not, and should not be taken as, an acknowledgement or any form of suggestion that the prior art forms part of the common general knowledge in any country.

### OBJECT OF THE INVENTION

It is an object of the present invention to provide a method and/or apparatus for automatically detecting a status of an oestrus indicator associated with an animal which will overcome and/or ameliorate problems with such apparatus and methods at present, or which will at least provide a useful choice.

Other objects of the present invention may become apparent from the following description, which is given by way of example only.

### BRIEF SUMMARY OF THE INVENTION

According to one aspect of the present invention there is provided an apparatus for automatically detecting a status of an oestrus indicator associated with an animal, the apparatus comprising:
a structure comprising two substantially parallel barrier means and moveable barrier means for selectively preventing an animal from proceeding between the parallel barrier means;
a camera for capturing an electronic image of an area of interest of the animal, the area of interest comprising an area of the animal which the oestrus indicator is usually associated with or attached to;
processing means for determining a status of the oestrus indicator based on the image; and
animal position sensing means;
wherein, in use, closing of the moveable barrier means is dependent on the animal position sensing means detecting that a required portion of the animal has moved past the moveable barrier means.

Preferably closing of the moveable barrier means is further dependent on the animal position sensing means detecting that a second animal is within a predetermined distance of the moveable barrier means.

Preferably the moveable barrier means open when the image has been captured and the animal position sensing means detects that the animal has moved a required distance from the moveable barrier means.

Preferably the animal position sensing means comprises a first sensor means for detecting when a fore part of the animal is in a first position which is indicative of the entire animal having moved past the moveable barrier means.

Preferably the animal position sensing means comprises a second sensor means for detecting when a rear of the animal has moved beyond a second position which is adjacent the moveable barrier means.

Preferably the camera captures an image of the area of interest when the second sensor means sense that the animal has moved beyond the second position.

Preferably the first sensor means comprises a photoelectric sensor.

Preferably the second position sensing means comprises a photoelectric sensor.

Preferably the animal position sensing means comprises the camera and the processing means.

Preferably the apparatus comprises or is, when in use, in communication with, a further position sensor positioned further from the moveable barrier means than the first sensor means.

Preferably the apparatus comprises an electronic ID reader.

Preferably the oestrus indicator comprises a pressure sensitive patch.

Preferably apparatus comprises a lighting means for artificially lighting an area which is within a field of view of the camera.

Preferably the intensity of the light inside the structure is adjustable.

Preferably the apparatus sends a signal to an automatic drafting gate depending on the status of the oestrus indicator.

Preferably the animal position sensing means comprises a drafting gate entry sensor.

Preferably the animal position sensing means comprises a drafting gate exit sensor.

According to a second aspect of the present invention there is provided a method of automatically detecting a status of an oestrus indicator associated with an animal, the method comprising the steps of:
i. providing a structure comprising two substantially parallel barrier means and moveable barrier means for selectively preventing the animal from proceeding between the parallel barrier means;
ii. allowing the animal to move past the moveable barrier means;
iii. determining whether to close the moveable barrier means based on a determination of whether a predetermined portion of the animal has moved through the moveable barrier means;
iv. capturing an electronic image of an area of interest, the area of interest comprising an area of the animal which the oestrus indicator is usually attached to or associated with;
v. processing the image to determine the status of the oestrus indicator.

Preferably the step of determining whether to close the moveable barrier means comprises the step of determining whether a second animal is within a predetermined distance of the moveable barrier means.

Preferably the method further comprises the step of automatically opening the moveable barrier means when the animal has moved a required distance from the moveable barrier means.

Preferably the method comprises receiving a signal from a first animal position sensor means when a fore part of the animal is in a first position which is indicative of the entire animal having moved past the moveable barrier means.

Preferably the method comprises receiving a signal from a second animal position sensor means when a rear of the animal has passed a second position which is adjacent the moveable barrier means.

Preferably the method comprises capturing the electronic image after receiving the signal from the second animal position sensing means.

Preferably the method comprises processing an output from the camera to determine when the area of interest of the animal is within the field of view of the camera.

Preferably the method comprises processing an output from the camera to determine when the predetermined portion of the animal has moved past the moveable barrier means.

Preferably the method comprises updating a herd management system depending on the status of the oestrus indicator.

Preferably the method comprises sending an automatic drafting gate a signal which is representative of the status of the oestrus indicator.

According to a further aspect of the present invention there is provided an apparatus for automatically detecting a status of an oestrus indicator associated with an animal substantially as herein described with reference to the accompanying figures.

According to a still further aspect of the invention there is provided an apparatus for automatically detecting a status of an oestrus indicator associated with an animal, the apparatus comprising:
a structure comprising two substantially parallel barrier means and moveable barrier means for selectively preventing an animal from proceeding between the parallel barrier means;
a camera for capturing an electronic image of an area of interest of the animal, the area of interest comprising an area of the animal which the oestrus indicator is usually associated with or attached to;
processing means for determining a status of the oestrus indicator based on the image; and
animal position sensing means;
wherein, in use, the moveable barrier means close behind the animal when the animal position sensing means detect that a required portion of the animal has moved past the moveable barrier means, the camera captures an image of at least the area of interest, and the moveable barrier means open when the image has been captured and the animal position sensing means detects that the animal has moved a required distance from the moveable barrier means.

According to a still further aspect of the invention there is provided a method of automatically detecting a status of an oestrus indicator associated with an animal, the method comprising the steps of:
i. providing a structure comprising two substantially parallel barrier means and moveable barrier means for selectively preventing the animal from proceeding between the parallel barrier means;
ii. allowing the animal to move past the moveable barrier means;
iii. closing the moveable barrier means when a predetermined portion of the animal has moved through the moveable barrier means;
iv. capturing an electronic image of an area of interest, the area of interest comprising an area of the animal which the oestrus indicator is usually attached to or associated with;
v. processing the image to determine the status of the oestrus indicator; and
vi. automatically opening the moveable barrier means when the animal has moved a required distance from the moveable barrier means.

Further aspects of the invention, which should be considered in all its novel aspects, will become apparent from the following description given by way of example of possible embodiments of the invention.

### BRIEF DESCRIPTION OF THE DRAWINGS

FIG. 1 is a diagrammatic side view of an apparatus according to one embodiment of the present invention.

FIG. 2 is a diagrammatic top view of the apparatus of FIG. 1, with the cover removed for clarity and the drafting gate positions shown in outline.

### BEST MODE

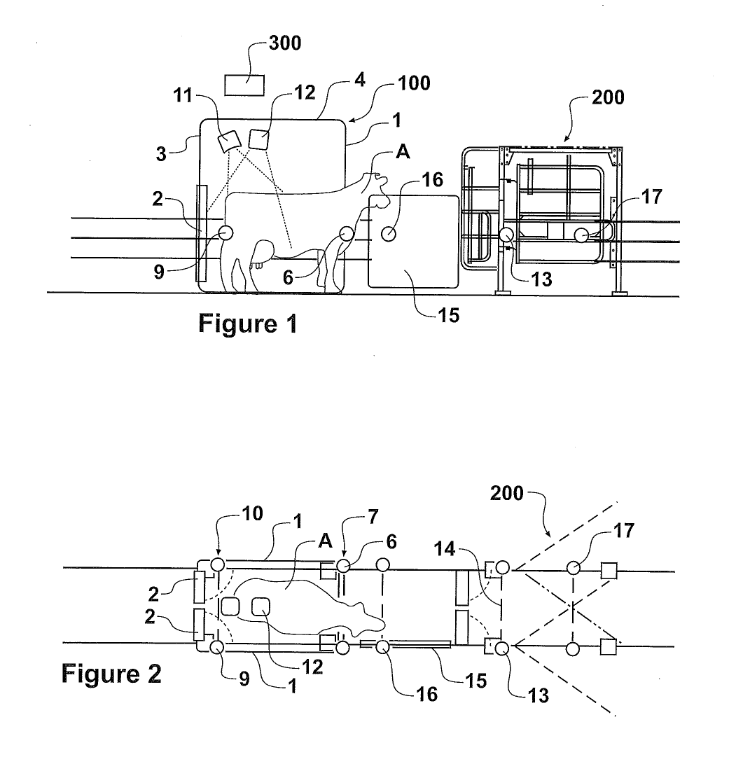

Referring first to FIGS. 1 and 2, an apparatus for detecting the reproductive status of an animal according to one embodiment of the present invention is generally reference by arrow 100. In preferred embodiments the animal is a bovine.

The apparatus 100 comprises two substantially parallel barrier means 1. The barrier means 1 may comprise a prior art cattle race, and are spaced apart sufficiently widely to allow an animal A to comfortably walk between them, but not so widely as to allow the animal A to turn around.

An automatically moveable barrier means 2 is provided, typically configured as a pair of pneumatically operated doors. The moveable barrier means 2 can be opened to allow animals A to proceed between the barrier means 2, or closed to prevent animals behind the barrier means 2 from proceeding forward and to prevent animals A in front of the barrier means 2 from moving backward.

In some embodiments a structure 3 comprising a cover 4 may be provided. The cover 4, if provided, must be sufficiently high that the animal is comfortable walking through the structure 3, but is preferably sufficiently low that at least the hind part of an animal inside the structure is in shadow. In some embodiments the cover 4 may extend partially or fully down the sides of the structure 3. In some embodiments the apparatus 100 may be provided with a walk-over weigh platform (not shown).

The apparatus 100 is provided with animal position sensing means for sensing the position of the animal A. In one embodiment the animal position sensing means comprise a photoelectric sensor 6 located at a first position 7 for sensing when a required portion of the animal has moved through the moveable barrier means. In one embodiment the first position sensor 7 is spaced apart from the moveable barrier means 2 by a distance which is approximately equal to the length of the animal, for example around 150 cm. The animal position sensing means may also comprise a second photoelectric sensor 9 located at a second position 10 which is substantially adjacent the moveable barrier means 2.

The apparatus 100 comprises an image capture means, typically a digital camera 11. The camera 11 is positioned such that the portion of the animal to which the heat detecting patch has been attached (typically including the sacrum and tailhead of the animal) is within the field of view of the camera 11. This portion of the animal is described herein as the “area of interest”.

In preferred embodiments no “exit” moveable barrier means are provided to halt the animal in the field of view of the camera 11. Providing such an exit barrier would reduce throughput through the apparatus.

In some embodiments an artificial lighting source 12 may be provided. The lighting source 12, if provided, is preferably adjustable (preferably automatically) to provide at least a minimum light level required by the camera 11.

Operation of a preferred embodiment of the apparatus 100 is as follows:

The moveable barrier means doors 2 are normally in the open position so that an animal A can move past the moveable barrier means 2 and into the field of view of the camera 11.

When the animal A has moved past the barrier means 2 the first photoelectric sensor 6 detects the presence of the head or chest of the animal A. Triggering of the first photoelectric sensor 6 causes the moveable barrier means 2 to close behind the animal A, preventing the animal from moving backwards, and preventing the head of another animal from entering the field of view of the camera.

Continued forward motion by the animal A moves the rear of the animal beyond the second position 10. When the second photoelectric sensor 9 detects that this has occurred, the camera 11 is triggered to record one or more images. In a preferred embodiment the camera 11 records a plurality of images, for example three images. In a preferred embodiment each image has a different exposure setting.

In typical embodiments the animals waiting to pass through the moveable barrier means 2 will be in a cattle race and will be want to move forward whenever possible. This is desirable, provided the animal in front continues moving away. However, in order to avoid the possibility of a third animal passing though the moveable barrier means 2 before the first animal has moved through at least one further moveable barrier means (such as a drafting gate, anti-backing flipper or other means of preventing the animal from moving backwards), the apparatus opens the moveable barrier means 2 when the animal position sensing means detect that the first animal has moved a required distance from the moveable barrier means 2.

In many embodiments the apparatus 100 will be used in conjunction with an automated drafting gate system 200. If the automated drafting gate system 200 is provided with a sensor 13 (for example a photoelectric sensor) to indicate that the animal has passed through the drafting gate entrance 14, a signal from this sensor 13 may be used to indicate that the moveable barrier means 2 can be opened.

In preferred embodiments the system comprises an EID reader 15. A further sensor 16 may be positioned to indicate that the animal is in position for the EID sensor to take a reading of an EID tag associated with the animal. If the EID reader 15 has not obtained a reading within a predetermined time of the sensor 16 indicating that the animal is in position, then the moveable barrier means 2 may kept closed until the animal has moved past another sensor 17 positioned at an exit of the drafting gates (if provided).

Those skilled in the art will appreciate that when the moveable barrier means 2 open to allow access to a second animal, the animal A which has just been processed by the apparatus 100 will be motivated to move away. In some embodiments further means for motivating the first animal A to move away from the moveable barrier means 2 may be provided, for example a nozzle configured to squirt compressed air towards the animal, or means (possibly pneumatic) for making a suitable noise.

The camera 11 is in communication with a processing means 300 which performs an analysis of the images taken from the camera 11 to determine the status of an oestrus/heat indicator which is attached to or associated with the animal A. The status may include “activated”, “not activated” or “missing/not found”.

In preferred embodiments only the results from certain animals are processed for oestrus detection. If the camera 11 cannot identify the presence of a heat detection indicator on an animal which is in the group being monitored for oestrus then the apparatus will treat the animal as if it had an activated oestrus detection indicator, as in some cases mounting behaviour can dislodge an indicator.

In preferred embodiments the processing means 300 may send a control signal to the automated drafting gates 200 depending on the analysis of the status of the oestrus indicator. For example, in-heat cows may be drafted into one area, cows which are not in-heat may be drafted into a second area (for example an entrance to a milking shed), and cows which have failed to be identified by the electronic ID reader may be drafted into a third area.

In some embodiments an animal may not be drafted into the on-heat area immediately on detection that the heat indicator has been activated. Instead, a record may be kept that the animal must be drafted at a later time.

In some embodiments the position sensing means may comprise the camera 11 and processing means 300. In these embodiments the first and second sensors 6, 9 may not be required, as the apparatus may be capable of determining when the animal is in the correct position to capture an image of the area of interest without the use of additional sensors. In these embodiments the camera 11 may operate substantially continuously while the apparatus is in use.

The processing means 300 may comprise any suitable image processing means of the prior art, for example Protrack™ EZ Heat® by Livestock Improvement Corporation Ltd (LIC).

In another embodiment (not shown) the position sensing means are operable to determine whether a second animal is within a predetermined distance, for example 100 cm, of the moveable barrier means 2. In one embodiment the position sensing means may comprise a further photoelectric sensor located substantially 100 cm in front of the moveable barrier means 2.

In this embodiment the moveable barrier means 2 may only close if another animal is within the predetermined distance. If no second animal is within the predetermined distance then the moveable barrier means may remain open in order to allow the next animal to move through the apparatus 100.

Although the invention has been described above with reference to its use with pressure sensitive heat detection patches, those skilled in the art will appreciate that the animal may be provided with any suitable alternative oestrus indicator. For example, in one embodiment the oestrus indicator may comprise a tail paint marking. In another embodiment the oestrus indicator may comprise a patch which has different infra-red characteristics when activated.

Those skilled in the art will appreciate that the present invention provides an apparatus and method for detecting the reproductive status of an animal which can be operated independently of a rotary milking shed and which creates a minimal disruption to the movement of the animals through the race.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the accompanying claims.

1. An apparatus for automatically detecting a status of an oestrus indicator associated with an animal, the apparatus comprising:
a structure comprising two substantially parallel barrier means and moveable barrier means for selectively preventing an animal from proceeding between the parallel barrier means to a first position;
a camera for capturing an electronic image of an area of interest of the animal in the first position, the area of interest comprising an area of the animal which the oestrus indicator is usually associated with or attached to;
processing means for determining a status of the oestrus indicator based on the image; and
animal position sensing means comprising a first sensor means and a further position sensor means positioned further from the moveable barrier means than the first sensor means;
wherein, in use, closing of the moveable barrier means is dependent on the first sensor means detecting that a required portion of the animal has moved past the moveable barrier means and opening of the moveable barrier means is dependent on the further position sensor means detecting that the animal has moved a required distance from the moveable barrier means.

2. The apparatus of claim 1 wherein closing of the moveable barrier means is further dependent on the animal position sensing means detecting that a second animal is within a predetermined distance of the moveable barrier means.

3. The apparatus of claim 1 wherein a second animal can move through the moveable barrier means before the first animal has passed through a further moveable barrier means.

4. The apparatus of claim 1 wherein the first sensor means detects when a fore part of the animal is in a first position which is indicative of the entire animal having moved past the moveable barrier means.

5. The apparatus of claim 4 wherein the animal position sensing means comprise a second sensor means for detecting when a rear of the animal has moved beyond a second position which is adjacent the moveable barrier means.

6. The apparatus of claim 5 wherein the camera captures an image of the area of interest when the second sensor means sense that the animal has moved beyond the second position.

7. The apparatus of claim 1 wherein the first sensor means and/or the further position sensor means comprise a photoelectric sensor.

8. (canceled)

9. The apparatus of claim 1, wherein the animal position sensing means comprises the camera and the processing means.

10. The apparatus of claim 1 comprising an electronic ID reader, and wherein the operation of the moveable barrier means is dependent on the electronic ID reader.

11-12. (canceled)

13. The apparatus of claim 1 comprising a lighting means for artificially lighting an area which is within a field of view of the camera.

14. The apparatus of claim 13 wherein the intensity of the light inside the structure is adjustable.

15. The apparatus of claim 1 wherein the apparatus sends a signal to an automatic drafting gate depending on the status of the oestrus indicator.

16.-17. (canceled)

18. A method of automatically detecting a status of an oestrus indicator associated with an animal, the method comprising the steps of:
(i) providing a structure comprising two substantially parallel barrier means and moveable barrier means for selectively preventing the animal from proceeding between the parallel barrier means to a first position;
(ii) allowing the animal to move past the moveable barrier means to the first position;
(iii) determining whether to close the moveable barrier means based on a determination of whether a predetermined portion of the animal has moved through the moveable barrier means;
(iv) capturing an electronic image of an area of interest of the animal in the first position, the area of interest comprising an area of the animal which the oestrus indicator is usually attached to or associated with;
(v) determining whether to open the moveable barrier means based on a determination of whether a predetermined portion of the animal has moved a required distance from the moveable barrier means; and
(vi) processing the image to determine the status of the oestrus indicator.

19. The method of claim 18 wherein the step of determining whether to close the moveable barrier means comprises the step of determining whether a second animal is within a predetermined distance of the moveable barrier means.

20. The method of claim 18 comprising the step of allowing a second animal to move through the moveable barrier means before the first animal has passed through a further moveable barrier means.

21. The method of claim 18 wherein the method comprises receiving a signal from a first animal position sensor means when a fore part of the animal is in a first position which is indicative of the entire animal having moved past the moveable barrier means.

22. The method of claim 21 comprising receiving a signal from a second animal position sensor means when a rear of the animal has passed a second position which is adjacent the moveable barrier means.

23. (canceled)

24. The method of claim 18 comprising processing the electronic image to determine when the area of interest of the animal is within the electronic image.

25. (canceled)

26. The method of claim 18 comprising updating a herd management system depending on the status of the oestrus indicator.

27. (canceled)

28. The method of claim 18 comprising receiving a reading from an electronic ID reader and operating the moveable barrier means dependent on the reading.
